(19) United States
(12) Patent Application Publication
(10) Pub. No.: US 2010/0106517 A1
(43) Pub. Date: Apr. 29, 2010

(54) SYSTEMS FOR AND METHODS OF MEDICAL SCHEDULING BASED ON SIMULATION-BASED OPTIMIZATION

(75) Inventors: Mariusz Kociubinski, Des Plaines, IL (US); VipulKumar Patel, Bartlett, IL (US); Wilkenson Chua, Lake Zurich, IL (US); Venkata Mrudula Gullapalli, Mount Prospect, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/257,113

(22) Filed: Oct. 23, 2008

(51) Int. Cl. G06Q 50/00

(52) U.S. Cl. 705/2

(57) ABSTRACT

Certain embodiments involve data from places such as healthcare facilities to make predictions about actual expected procedure durations as well as other parameters such as the probability of a patient being late or being a no-show. Before scheduling a patient, the system will use these parameters to run a simulation that can then suggest time slots that maximize target service levels (for example, “patients should not wait longer than 15 minutes in 95% of the cases”) and maximize facility efficiency (minimize the unutilized time between appointments).

### RELATED APPLICATIONS

Not Applicable

### FEDERALLY SPONSORED RESEARCH OR DEVELOPMENT

Not Applicable

### MICROFICHE/COPYRIGHT REFERENCE

Not Applicable

### BACKGROUND TO THE INVENTION

The invention relates generally to scheduling optimization systems and methods of creating optimal schedules for businesses, and more particularly to scheduling systems in the clinical setting, such as healthcare delivery institutions or hospitals.

Many healthcare delivery institutions (for example radiology clinics or hospital departments) utilize applications such as RIS (Radiology Information Systems) to enable scheduling of examinations for patients. Such systems keep track of existing schedules for a given room/scanner/technologist and fit patients into empty slots according to the availability of space, equipment, and necessary personnel. Slot durations are pre-configured for procedures ahead of time. However, there is significant variability as to how long an examination may actually take. Such deviations from the pre-determined duration lead to inefficiencies. For example, if the procedure takes less time than expected, the facility's time is not being utilized optimally because of the open room, unused equipment or available technologist. If the procedure takes more time than expected, subsequent patients are forced to wait, equipment is potentially tied up when needed elsewhere, and technologist and possibly other employee schedules are altered. Other events like patient no-shows, longer-than expected check-in or registration times, or late arrivals disrupt existing schedules and create undesired repercussions (for example, other patients having to wait, staff not being fully utilized).

Up until this point, schedule optimization has been addressed by training schedulers to over-book or under-book depending on loosely defined rules and anecdotal evidence. Some predictive scheduling systems exist, such as that described in published US Application 20070203761A1, such systems make use of only limited historical data. Such systems are limited by their lack of a broad range of predictive inputs (such as patient demographics, environmental considerations or insurance information). Other systems rely almost exclusively on predicting the efficiency of the technologist, as is the case with published US Application US20070073556A1. Still other systems such as the one described in published US Application US20050234741A1 enable patients to schedule their own appointments.

Previous attempts at utilizing forecasting techniques for scheduling were narrow in scope and were relegated to using only historical procedure duration data to make better predictions about the duration of future procedures. There is therefore a need for a comprehensive system and method for scheduling clinical activities and procedures that incorporate historical inputs as well as predictive information that minimizes the inefficiencies caused by variations in scheduled procedures.

The idea of using statistical tools and applying them to medical scheduling is novel. Certain embodiments of this new system analyze a variety of data, infer additional information and perform more sophisticated optimization by applying tools such as Monte Carlo simulation techniques.

### SUMMARY OF THE INVENTION

Certain embodiments involve using existing facility data to make predictions about actual expected procedure duration as well as other parameters such as the probability of a patient being late or being a no-show. Before scheduling a patient, the system will use these parameters to run a Monte Carlo simulation that takes as inputs the current facility schedule and patients' constraints (for example, Patient A is only available mornings before 11:00 A.M.). The objective of the simulation is to suggest time slots that maximize the target service level (for example, “patients should not wait longer than 15 minutes in 95% of the cases”) and maximize facility efficiency (minimize the unutilized time between appointments).

By suggesting time slots that are most likely to reduce wait times of other patients and to minimize unutilized time and resources of the facility, the system will improve patient satisfaction and the efficiency of the facility.

Certain embodiments of the system solve the problem of sub-optimal utilization of a facility's time and resources caused by events like patients being later for appointments, procedures taking longer than expected, patients not show up for appointments, patients having to wait longer than anticipated for their procedure, and other issues that are inherent to scheduling at a healthcare delivery institution or hospital.

### DESCRIPTION OF THE DRAWINGS

These and other features, aspects and advantages of the present invention will become better understood when the following detailed description is read with reference to the accompanying drawings in which like characters represent like parts throughout the drawings. The embodiments shown in the drawings are presented for purposes of illustration only. It should be understood, however, that the present invention is not limited to the arrangements and instrumentality shown in the attached drawings.

### DETAILED DESCRIPTION

Certain embodiments of the system will analyze selected patient demographics and procedure characteristics along with historical information to calculate parameters that will be used to optimize the scheduling of procedures at the healthcare delivery institution or hospital. Specific characteristics of a patient's profile are helpful in predicting the amount of time a particular procedure will take. For example, if the patient is in a wheelchair, the likelihood of the procedure taking longer increases. If, for example, a patient scheduled for a particular procedure at a hospital is already staying at the hospital for other in-patient procedures, the likelihood of a no-show decreases substantially. Based on such inferences along with historical data, a probability of occurrence (for example, of a no-show) or an exact point estimate (for example, of a procedure duration) will be calculated.

There are selected parameters that will be calculated in certain embodiments in order to arrive at a prediction to help optimize the scheduling process.

For example, the probability of a no-show is a parameter that can be determined with some degree of accuracy using: the patient's history of being late/no-show, the day of the week and the corresponding relation to tardiness of skipped appointments, the time of the year (for example, the holidays), the weather forecast, the type of insurance, a patient's need for assistance, the type of patient (for example, inpatient, outpatient, VIP). A patient's history of tardiness or skipping appointments may suggest a greater likelihood of future missed appointments. Likewise, the particular day of the week or time of the year may suggest a higher or lower likelihood of missed appointments. Inclement weather can cause patients to skip appointments. The type of insurance a patient has may suggest a higher likelihood for the patient being a no-show. Patients with special needs, such as those in wheelchairs, may be more or less likely to be unable to make it to an appointment. Additionally, a patient's status as inpatient or outpatient will affect their attendance. Patients that are already on site are less likely to miss appointments. Still other patients may have special status with the treatment facility which may affect their propensity to show up or miss appointments.

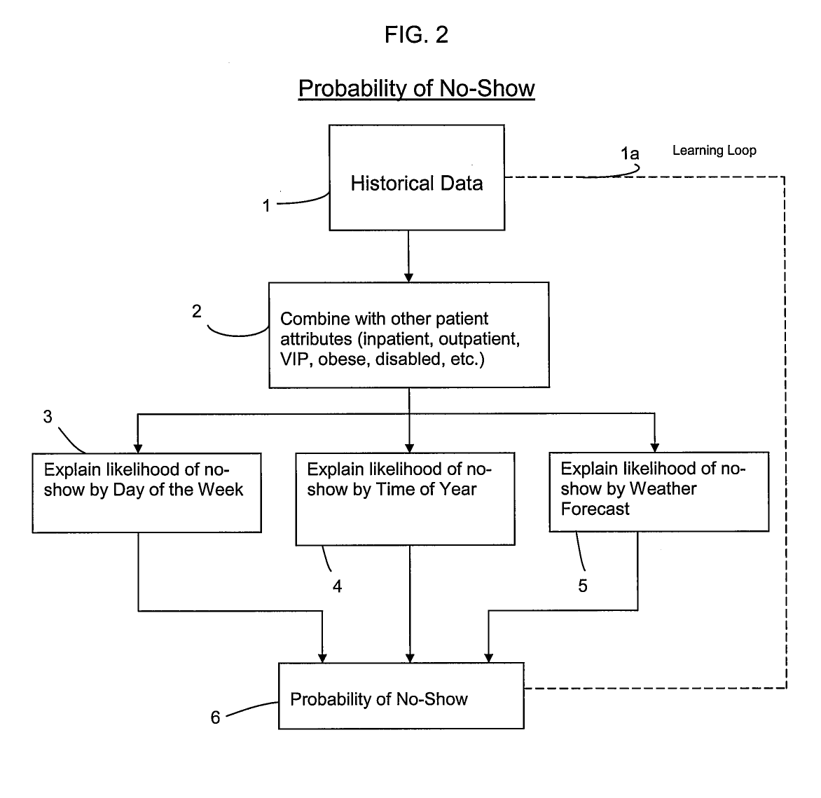

Referring to FIG. 2, an embodiment for a Probability of No-Show Estimator module is shown. No-show estimation is accomplished depending upon the information initially available, for example a history of the patient's attendance 1 is a starting point. As the patient has more and more appointments, the learning loop 1a adds the information to reduce the forecast's margin or error by incorporating the additional information. In an embodiment of a No-show estimator as shown in FIG. 2, a procedure is scheduled with the knowledge of the probability of a patient's absence. In addition to the patient's attendance history, other information is considered such as the patient attributes (for example, inpatient, outpatient, obesity, disability) 2. Additionally, other factors that affect attendance are considered in accordance with the relative weight afforded such things as the day of the week 3, the time of year 4, or the weather forecast 5. The probabilities predicted by the system can be weighed against actual statistics and adjusted accordingly.

Another parameter that will be used in certain embodiments to predict an optimal schedule is the probability that a patient will be late and the expected length of the delay. Information needed to determine the probability that a patient will be late may include the patient's history of being late or skipping appointments, the particular day of the week, the time of the year (for example, it may be the holidays), traffic patterns, expected weather, the distance from the patient's home to the facility, the need for special assistance, and the patient type (for example, inpatient/outpatient/VIP). A similar process as that used to determine the probability of a no-show (FIG. 2) will be used by substituting the information that is relevant to tardiness for the information that is relevant to absence (to the extent there is a difference).

Another parameter that will be used in certain embodiments to predict an optimal schedule is the probability that a patient will refuse the treatment. For example, a patient is more likely to refuse to climb onto a closed MRI machine if they suffer from claustrophobia. Information needed to determine the probability that a patient will refuse treatment will include any information the facility has about the patient having any special conditions (for example, claustrophobia) and the type of procedure (for example, is it a procedure that requires a patient suffering from claustrophobia to be in an enclosed space?). A similar process as that used to determine the probability of a no-show (FIG. 2) will be used by substituting the information that is relevant to refusal of treatment (as described in this paragraph) for the information that is relevant to absence.

Another parameter that will be used in certain embodiments to predict an optimal schedule is the expected duration of a procedure. Information needed to determine the expected duration of the procedure includes the past history and performance of the technologist, the patient demographics, disease characteristics, and historical data on the duration of the particular procedure. One technologist may work considerably faster or slower than another technologist. Patient demographics may suggest that a procedure will taken longer or go quicker. For example, an obese patient may take longer to examine than other patients, a person's age may likewise affect such results, a patient with a disability may require a longer setup or examination, and other factors such as a patient's nationality may be useful in determining the expected duration of the examination. The characteristics of a patient's ailment (disease type and progression) may suggest a longer or shorter examination time. Historical data, using the actual duration times of similar procedures in the past, can also be used to predict future examination duration.

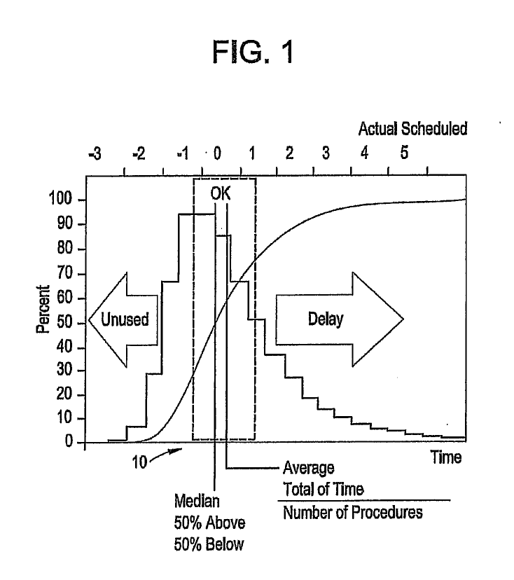

Referring to FIG. 1, a representative illustration of how variation impacts scheduling is shown. Typically the average time for a given procedure is subject to variation due to a variety of reasons as described in the previous paragraph. However, a healthcare institution or hospital currently schedules procedures based on the average time duration per procedure. Therefore, if a number of procedures take longer than expected then the remainder of scheduled procedures may be delayed or have to be rescheduled. Conversely, if procedures take less time than expected then there is a risk of unused availability. Both underutilization and scheduling delays are costly in time and resources. Using the available information, as described above, it may be useful in certain embodiments to determine the median, average and the anticipated variation such as by using the concept of standard deviation. Within this window 10, indicated by a dotted line, illustrates a projected duration for a particular procedure using the available information.

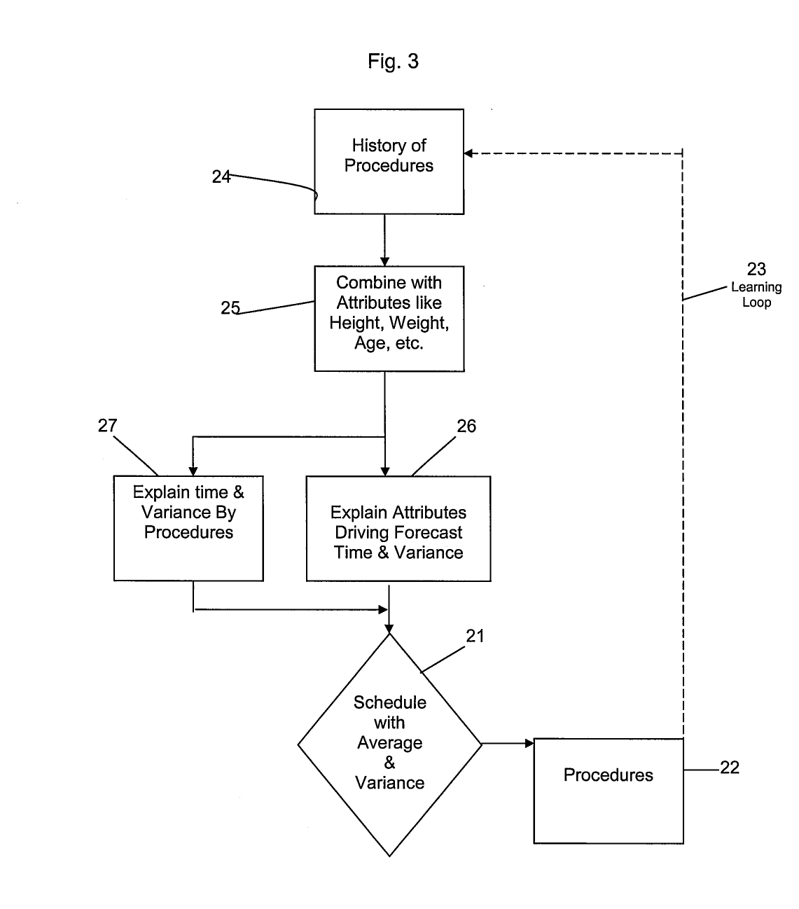

Referring to FIG. 3, an embodiment for a Duration Estimator module is shown. Duration estimation is accomplished depending upon the information initially available, for example a history of procedures 24, and then a learning loop 23 is implemented that reduces the forecast error by incorporating additional information such as accurate case times and well measured descriptive attributes that serve as leading indicators. In an embodiment of a duration estimation as shown in FIG. 2, a procedure is scheduled with average known time and variance at step 21 for a procedure, for example in the operating room (OR) at step 22. Additionally, the history 24, like attributes 25, and variation explained at steps 26 and 27 are then incorporated into forecasting and scheduling. In the absence of a historical record, duration estimation is achieved via expert input (not shown separately but can be included in history 24). Historical data of recorded procedures and their duration are more desirous than strictly expert opinion. A preliminary analytical step is to characterize the accuracy (mean and statistical variation) of historical procedure duration versus actual duration for like cases. A measure of duration classification is made and its degree of uncertainty is established.

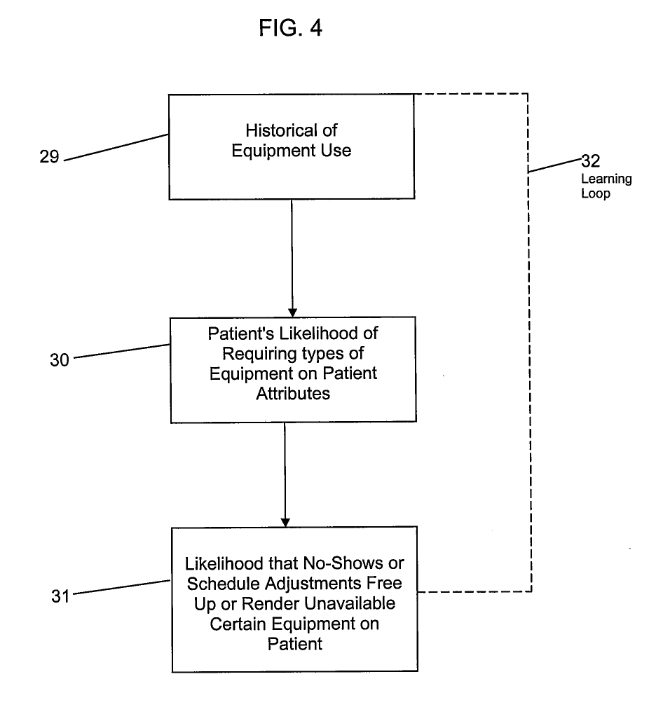

Another parameter that will be used in certain embodiments to predict an optimal schedule is the availability of resources such as the facilities and the equipment. Using historical data and analyzing it against the facility's current workload and the type of procedures that are scheduled at various times, a probability that, for example, a particular examination room or a particular piece of equipment will be calculated. FIG. 4 illustrates how one embodiment of such an availability of resources estimator may work. Historical data, such as the facilities number of pieces of equipment and historical use of such equipment will be considered. In combination with this information, a patient's attributes will be considered in order to determine the likelihood that they will require the use of particular equipment during their examination. Other information, such as the likelihood that no-shows or tardiness will render certain equipment unavailable at certain times or free up such equipment will be considered. Finally, a calculated probability of equipment availability will result from the various inputs.

In certain embodiments, the system will analyze the available information about the patient (for example, his or her age, obesity, or handicap) and the circumstances (for example, the patient's insurance type, availability of rooms, equipment and technologist time, and the patient's disease type) to calculate the above mentioned parameters. In addition to calculating a point estimate for each parameter, the system will also fit a distribution (for example, normal, exponential, or logarithmic) to more accurately capture the variation within the parameter.

Before scheduling a new appointment, the system will analyze the current schedule, the patient's preferences/constraints (for example, the patient may only be available mornings before 11:00 AM) and will run a Monte Carlo simulation whose objective is to maximize the service levels (for example, “patients should not wait longer than 15 minutes in 95% of the cases”) and maximize efficiency (unutilized time between appointments). This optimization via simulation involves calculating, for each possible time slot, the expected service level along with the expected efficiency measurement. The system will then optimize the outcome by picking the first best option.

Based on the output of the simulation, the system will suggest not only the first empty available slot, but instead one that meets the patient's constraints while minimizing wait time for other patients and minimizing the unutilized time for the facility.

In certain embodiments, the system will draw inferences in order to accurately calculate parameters. For example, a patient who is obese or has a disability is likely to take more time during an examination. Based on historical data and procedure type, the expected duration of the procedure can be predicted with some degree of accuracy. Another example is that an in-patient is unlikely to be late or be a no-show for an appointment because the person is already on site and may even have an employee prompting them to attend certain appointments. Similarly, the system may draw the inference that an inexperienced technologist is likely to take longer than normal to perform a procedure.

In certain embodiments of the system, the parameters, once calculated, will be used to create an optimal schedule that achieves pre-determined goals. For example, a patient who is likely to be late for an appointment will be scheduled to follow an examination that is likely to take longer than normal (thereby minimizing unutilized time). A patient who is likely to take longer for a procedure (for example, because of a handicap) will be scheduled before a patient who is likely to take less time than usual. A patient who is likely to be a no-show is scheduled during a flexible time when a no-show is not likely to disrupt operations.

If utilized, systems as described herein will promote higher efficiency among healthcare delivery institutions or hospitals by minimizing unutilized time and optimizing resource utilization. This increased efficiency will lead to higher productivity, better patient care, and better return on investment. Better resource utilization, through the use of certain embodiments of this system, will inevitably lead to better resource planning, more predictable working schedules, and higher job satisfaction by the staff. Minimizing wait times for appointments will also improve overall patient satisfaction.

Applications currently exist that provide a facility with patient and procedure scheduling. Certain embodiments of the system can be adapted to be used with these existing applications (such as RIS) or embodiments of the system can be implemented as part of a customized application.

The system will analyze the current schedule, the patient's preferences/constraints (for example, the patient may only be available mornings before 11:00 AM) and will run a Monte Carlo simulation whose objective is to maximize the service levels (for example, “patients should not wait longer than 15 minutes in 95% of the cases”) and maximize efficiency (unutilized time between appointments). This optimization via simulation involves calculating, for each possible time slot, the expected service level along with the expected efficiency measurement. The system will then optimize the outcome by picking the first best option.

1. A method for deriving a schedule for patient appointments, said method comprising:
processing input data in order to arrive at probabilities;
conducting a simulation using input data and at least one of said probabilities;
determining at least one time and date for a patient appointment based on at least one of said probabilities;
enabling a user to view the suggested at least one time and date for a patient appointment.

2. The method of claim 1, wherein said input data includes at least one of patient demographics, procedure characteristics and historical information.

3. The method of claim 1, wherein said input data includes the probability of a patient not being at the scheduled appointment at the scheduled time and date, said probability being determined based information comprising, if known:
a. a patient's history of being late to appointments;
b. the expected traffic and weather patterns based on the given day and time of the appointment;
c. the patient's status as inpatient or outpatient; and
d. the patient's disabilities or other health factors that may cause or correlate with delays or absences.

4. The method of claim 1, wherein said input data includes the expected duration of a procedure, said expected duration being predicted based on information comprising, if known:
a. the practitioner's history of performing the scheduled procedure;
b. the patient's health; and
c. the type and progression of the patient's condition.

5. The method of claim 1, wherein said input data includes the availability of examination rooms and equipment used for examination.

6. The method of claim 1, wherein said input data comprises:
a. a patient's probability of a no-show;
b. a patient's probability of being late for an appointment;
c. a patient's probability of refusing treatment;
d. the expected duration of a procedure; and
e. the availability of resources.

7. The method of claim 1, wherein said probabilities are translated into a point estimate in which a compilation of the point estimates will fit a normal, exponential or logarithmic distribution.

8. The method of claim 1, wherein patients who are more likely than average to be late for an appointment will be scheduled in the simulation after a patient whose appointment duration is more likely to be longer than average.

9. The method of claim 1, wherein patients who are likely to have a longer than average appointment duration will be scheduled in the simulation before a patient who is likely to take less time than average.

10. A scheduling system for viewing a proposed schedule, said system comprising:
an input module processing input demographic data indicating a patient status; and
a scheduling module deriving a proposed schedule including at least one patient appointment at a given time and date based on a simulation using selected demographic and historical information as input, said scheduling module adapting said at least one patient appointment at a given time and date based on said demographic and historical data.

11. The system of claim 10, further comprising a user interface module configured to allow a user to monitor said proposed schedule and the demographic and historical information and to make adjustments to such information.

12. The system of claim 10, wherein said scheduling module creates a proposed schedule, using a simulation based on at least the probability that a patient will be at a schedule appointment at a particular date and time and the expected duration of time of the appointment.

13. The system of claim 10, wherein said scheduling module determines, using a simulation-based method using probabilities derived from patient demographics, procedure characteristics and historical information.

14. The system of claim 10, wherein said probabilities comprise:
a. a patient's probability of a no-show;
b. a patient's probability of being late for an appointment;
c. a patient's probability of refusing treatment;
d. the expected duration of a procedure; and
e. the availability of resources.

15. A computer-readable medium comprising a set of instructions for causing a computer to:
process input data in order to arrive at probabilities;
conduct a simulation using input data and/or at least one of said probabilities;
determine at least one time and date for a patient appointment based on input data and/or at least one of said probabilities; and
instruct at least one time and date for a patient appointment to be displayed.

16. The computer-readable medium of claim 15, wherein said input data includes at least one of patient demographics, procedure characteristics and historical information.

17. The computer-readable medium of claim 15, wherein said input data includes the probability of a patient not being at the scheduled appointment at the scheduled time and date, said probability being determined based information comprising, if known:
a. a patient's history of being late to appointments;
b. the expected traffic and weather patterns based on the given day and time of the appointment;
c. the patient's status as inpatient or outpatient; and
d. the patient's disabilities or other health factors that may cause or correlate with delays or absences.

18. The computer-readable medium of claim 15, wherein said input data includes the expected duration of a procedure, said expected duration being predicted based on information comprising, if known:
a. the practitioner's history of performing the scheduled procedure;
b. the patient's health; and
c. the type and/or progression of the patient's condition.

19. The computer-readable medium of claim 15, wherein said input data includes the availability of examination rooms and equipment used for examination.

20. The computer-readable medium of claim 15, wherein said input data comprises:
a. a patient's probability of a no-show;
b. a patient's probability of being late for an appointment;
c. a patient's probability of refusing treatment;
d. the expected duration of a procedure; and
e. the availability of resources.
